(19) United States
(12) Patent Application Publication
(10) Pub. No.: US 2011/0035540 A1
(43) Pub. Date: Feb. 10, 2011

(54) FLASH BLADE SYSTEM ARCHITECTURE AND METHOD

(75) Inventors: Alan A. Fitzgerald, Gilbert, AZ (US); Robert W. Ellis, Phoenix, AZ (US); Scott Harrow, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: ADTRON, INC., Phoenix, AZ (US)

(21) Appl. No.: 12/853,953

(22) Filed: Aug. 10, 2010

Related U.S. Application Data
(60) Provisional application No. 61/232,712, filed on Aug. 10, 2009.

(51) Int. Cl. G06F 12/00; G06F 12/02

(52) U.S. Cl. 711/103; 711/E12.001; 711/E12.008

(57) ABSTRACT

A flash blade and associated methods enable improved areal density of information storage, reduced power consumption, decreased cost, increased IOPS, and/or elimination of unnecessary legacy components. In various embodiments, a flash blade comprises a host blade controller, a switched fabric, and one or more storage elements configured as flash DIMMs. Storage space provided by the flash DIMMs may be presented to a user in a configurable manner. Flash DIMMs, rather than magnetic disk drives or solid state drives, are the field-replaceable unit, enabling improved customization and cost savings.

### CROSS REFERENCE TO RELATED APPLICATIONS

This application is a non-provisional of U.S. Provisional No. 61/232,712 filed on Aug. 10, 2009 and entitled “FLASH BLADE SYSTEM ARCHITECTURE AND METHOD.” The entire contents of the foregoing application are hereby incorporated by reference.

### TECHNICAL FIELD

The present disclosure relates to information storage, particularly storage in flash memory systems and devices.

### BACKGROUND

Prior data storage systems, for example RAID SAN/NAS topologies, typically comprise a high speed network I/O component, a local data cache, and multiple hard disk drives. In these systems, the field replaceable unit is the disk drive, and drives may typically be removed, added, hot-swapped, and/or the like as desired. These systems typically draw a base power amount (for example, 200 watts) plus a per-drive power amount (for example, 12 watts to 20 watts), leading to systems that consume many hundreds of watts of power directly, and require significant amounts of additional power for cooling the buildings in which they are housed.

In recent years, solid-state drives (SSDs) incorporating flash memory storage elements have become an attractive alternative to conventional hard disk drives based on rotating magnetic platters. Typically, SSDs have been configured to be direct replacements for hard disk drives, and offer various advantages such as lower power consumption. As such, SSDs typically incorporate simple controllers with a single array of flash memory, and a direct connection to a SCSI, IDE, or SATA host. SSDs are typically contained in a standard 2.5″ or 3.5″ enclosure.

However, this approach to using flash memory in information storage systems has various limitations, for example increased processing and/or bandwidth overhead due to use of legacy disk drive components and/or protocols, reduced areal density of flash chips, increased power consumption, and so forth.

### SUMMARY

This disclosure relates to information storage and retrieval. In an exemplary embodiment, a method for managing payload data comprises, responsive to a payload data storage request, receiving payload data at a flash blade. The payload data is stored in a flash DIMM on the flash blade. Responsive to a payload data retrieval request, payload data is retrieved from the flash DIMM.

In another exemplary embodiment, a method for storing information comprises providing a flash blade having an information storage area thereon. The information storage area comprises a plurality of information storage components. In the information storage area, at least one portion of information is stored. At least one of the information storage components is replaced while the flash blade is operational.

In yet another exemplary embodiment, a flash blade comprises a host blade controller configured to process payload data, and a flash DIMM configured to store the payload data. The flash blade further comprises a switched fabric configured to facilitate communication between the host blade controller and the flash DIMM.

In yet another exemplary embodiment, a non-transitory computer-readable medium has instructions stored thereon that, if executed by a system, cause the system to perform operations comprising, responsive to a payload data storage request, receiving payload data at a flash blade. The payload data is stored in a flash DIMM on the flash blade. Responsive to a payload data retrieval request, payload data is retrieved from the flash DIMM.

The contents of this summary section are provided only as a simplified introduction to the disclosure, and are not intended to be used to limit the scope of the appended claims.

### BRIEF DESCRIPTION OF THE DRAWINGS

With reference to the following description, appended claims, and accompanying drawings:

FIG. 1 illustrates a block diagram of an information management system in accordance with an exemplary embodiment;

FIG. 2A illustrates an information management system configured as a flash blade in accordance with an exemplary embodiment;

FIG. 2B is a graphical rendering of a flash blade in accordance with an exemplary embodiment;

FIG. 3A illustrates a storage element configured as a flash DIMM in accordance with an exemplary embodiment;

FIG. 3B illustrates a block diagram of a flash DIMM in accordance with an exemplary embodiment;

FIG. 3C illustrates a block diagram of a flash chip containing erase blocks in accordance with an exemplary embodiment;

FIG. 3D illustrates a block diagram of an erase block containing pages in accordance with an exemplary embodiment; and

FIG. 4 illustrates a method for utilizing flash DIMMs in a flash blade in accordance with an exemplary embodiment.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the present disclosure.

For the sake of brevity, conventional techniques for information management, communications protocols, networking, flash memory management, and/or the like may not be described in detail herein. Furthermore, the connecting lines shown in various figures contained herein are intended to represent exemplary functional relationships and/or physical and/or communicative couplings between various elements. It should be noted that many alternative or additional functional relationships, physical connections, and/or communicative relationships may be present in a practical information management system, for example a flash blade architecture.

For purposes of convenience, the following definitions may be used in this disclosure:

A page is a logical unit of flash memory.

An erase block is a logical unit of flash memory containing multiple pages.

Payload data is data stored and/or retrieved responsive to a request from a host, for example a host computer or other external data source.

Wear leveling is a process by which locations in flash memory are utilized such that at least a portion of flash memory ages substantially uniformly, reducing localized overuse and associated failure of individual, isolated locations.

Metadata is data related to a portion of payload data (for example, one page of payload data), which may provide identification information, support information, and/or other information to assist in managing payload data, such as to assist in determining the position of payload data within a data storage context, for example a data storage context as understood by a host computer or other external entity.

A flash DIMM is a physical component containing a portion of flash memory. For example, a flash DIMM may comprise a single in-line memory module (SIMM), a dual in-line memory module (DIMM), a single integrated circuit package or “chip”, and/or the like. Moreover, a flash DIMM may comprise any suitable chips, configurations, shapes, sizes, layouts, printed circuit boards, traces, and/or the like, as desired, and the use of such variations is included within the scope of this disclosure.

A storage blade is a modular structure comprising non-volatile memory storage units for storage of payload data.

A flash blade is a storage blade wherein the non-volatile memory storage units are flash DIMMs.

Improved data storage flexibility, improved areal density, reduced power consumption, reduced processing and/or bandwidth overhead, and/or the like may desirably be achieved via use of an information management system, for example an information management system configured as a flash blade, wherein a portion of flash memory, rather than a disk drive, is the field-replaceable unit.

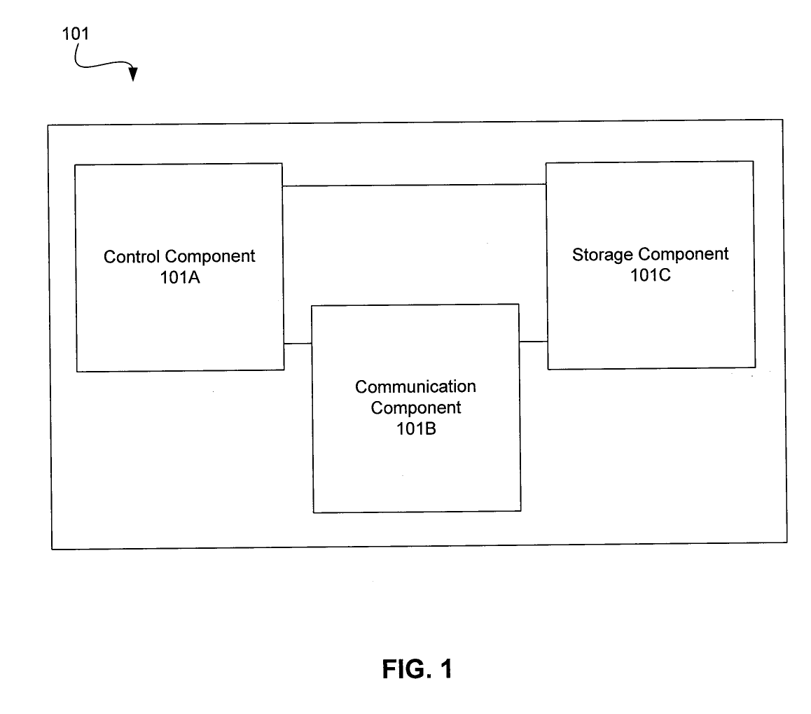

An information management system, for example a flash blade, may be any system configured to facilitate storage and retrieval of payload data. In accordance with an exemplary embodiment, and with reference to FIG. 1, an information management system 101 generally comprises a control component 101A, a communication component 101B, and a storage component 101C. Control component 101A is configured to control operation of information management system 101. For example, control component 101A may be configured to process incoming payload data, retrieve stored payload data for delivery responsive to a read request, communicate with an external host computer, and/or the like. Communication component 101B is coupled to control component 101A and to storage component 101C. Communication component 101B is configured to facilitate communication between control component 101A and storage component 101C. Additionally, communication component 101B may be configured to facilitate communication between multiple control components 101A and/or storage components 101C. Storage component 101C is configured to facilitate storage, retrieval, encryption, decryption, error detection, error correction, flash management, wear leveling, payload data conditioning and/or any other suitable operations on payload data, metadata, and/or the like.

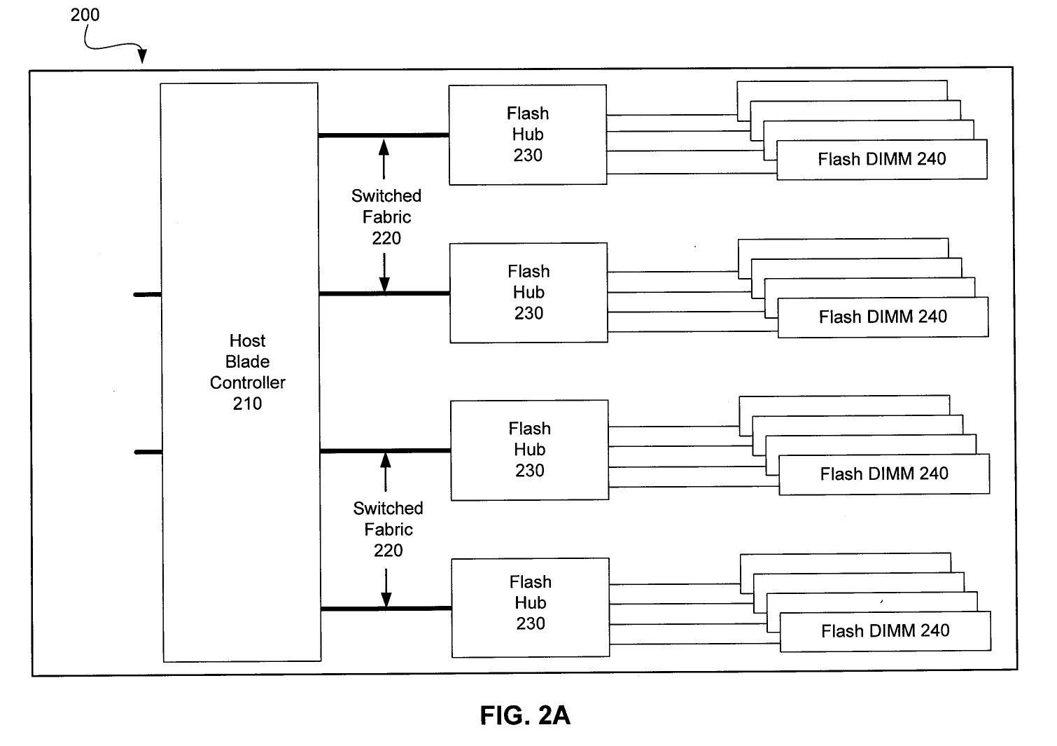

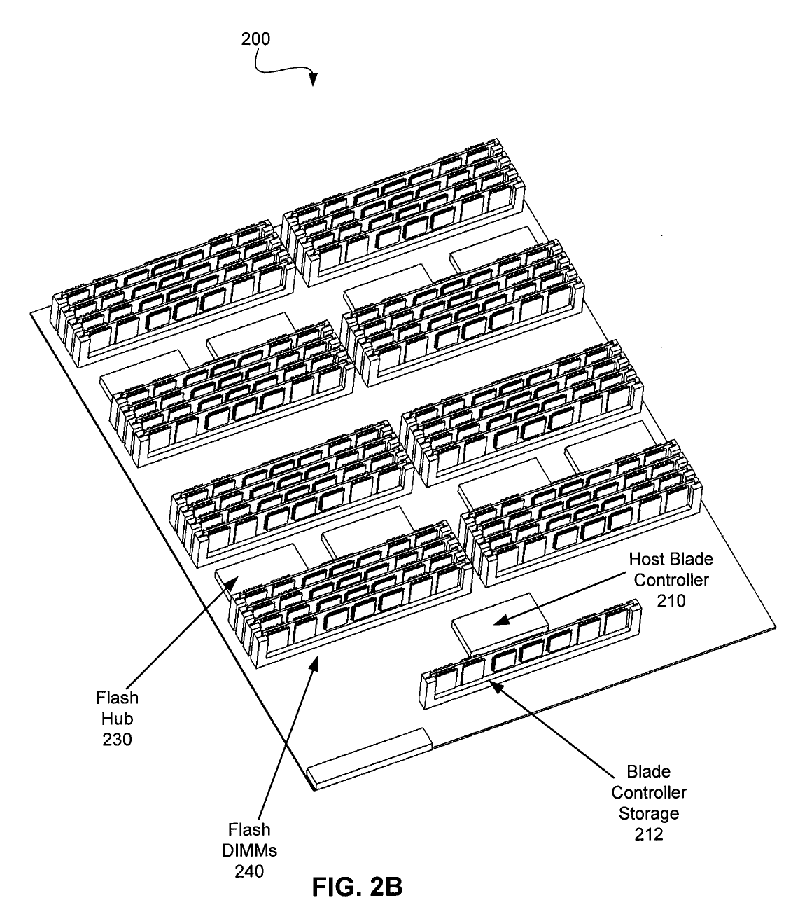

With reference now to FIGS. 2A and 2B, and in accordance with an exemplary embodiment, an information management system 101 (for example, flash blade 200) comprises a host blade controller 210, a switched fabric 220, a flash hub 230, and a flash DIMM 240. Flash blade 200 is configured to be compatible with a blade enclosure as is known in the art. For example, flash blade 200 may be configured without power supply components and/or cooling components, as these can be provided by a blade enclosure. Moreover, flash blade 200 may be configured with a standard form factor, for example 1 rack unit (1U). However, flash blade 200 may be configured with any suitable form factor, dimensions, and/or components, as desired. Flash blade 200 may be further configured to be compatible with one or more input/output protocols, for example Fibre Channel, Serial Attached Small Computer Systems Interface (SAS), PCI-Express, and/or the like, in order to allow storage and retrieval of payload data by a user. Moreover, flash blade 200 may be configured with any suitable components and/or protocols configured to allow flash blade 200 to communicate across a network.

In various exemplary embodiments, flash blade 200 is configured with a plurality of DIMM sockets, each configured to accept a flash DIMM 240. In an exemplary embodiment, flash blade 200 is configured with 32 DIMM sockets. In another exemplary embodiment, flash blade 200 is configured with 64 DIMM sockets. Moreover, flash blade 200 may be configured with any desired number of DIMM sockets and/or flash DIMMs 240. For example, a particular flash blade 200 may be configured with 16 DIMM sockets, and 4 of these DIMM sockets may contain a flash DIMM 240. In this manner, flash blade 200 is configured to utilize multiple flash DIMMs 240, as desired.

Additionally, flash blade 200 may be configured to allow a user to add and/or remove one or more flash DIMMs 240. For example, additional flash DIMMs 240 may be placed in an empty DIMM socket in order to increase the storage capacity of flash blade 200. Alternatively, flash blade 200 may be initially configured with a small number of flash DIMMs 240, for example 4 flash DIMMs 240, allowing the expense of flash blade 200 to be reduced. A purchaser may later purchase and install additional flash DIMMs 240, allowing expenses associated with flash blade 200 to be spread over a desired timeframe. Further, because additional flash DIMMs 240 may be added to flash blade 200, the storage capacity of flash blade 200 may grow responsive to increased storage demands of a user. In this manner, the expense and/or capacity of flash blade 200 may be more closely matched to the desires of a purchaser and/or user.

In addition to being configurable by modifying the number of associated flash DIMMs 240, flash blade 200 is configured to be operable over a wide range of ambient temperatures. For example, flash blade 200 may be configured to be operable at an ambient temperature that is higher than a conventional storage blade server having one or more magnetic disks. In various exemplary embodiments, flash blade 200 is configured to be operable at an ambient temperature of between about 0 degrees Celsius and about 70 degrees Celsius. In an exemplary embodiment, flash blade 200 is configured to be operable at an ambient temperature of between about 40 degrees Celsius and about 50 degrees Celsius. In contrast, data centers utilizing typical storage blade servers are often configured with cooling systems in order to provide an ambient temperature at or below 20 degrees Celsius. In this manner, flash blade 200 can facilitate power savings in a data center or other location utilizing a flash blade 200, as significantly less power may be needed for cooling the ambient air. Additionally, depending on the installed location of flash blade 200 and associated ambient temperature, no cooling or little cooling may be needed, and existing uncooled ambient air may be sufficient to keep the temperature in the data center at a suitable level.

In various exemplary embodiments, flash blade 200 can reduce operating costs associated with power directly drawn by flash blade 200. For example, a conventional storage blade server having four magnetic disk drives may draw 150 watts of base power and 15 watts of power per disk drive, for a total system power consumption of 210 watts. In contrast, in an exemplary embodiment a flash blade 200 configured with thirty-two flash DIMMs 240 may draw 50 watts of base power and 2 watts of power per flash DIMM 240, for a total system power consumption of 114 watts. Moreover, adding magnetic drives to a conventional storage blade server in order to increase storage capacity quickly increases the total power consumed by the storage blade server. In contrast, the total power consumed by flash blade 200 increases by only a small amount (for example, by about 2 watts) with each additional flash DIMM 240. Moreover, a particular flash DIMM 240 may be powered down when not in use, resulting in additional power savings. As such, flash blade 200 can enable improvements in the amount of payload data that can be stored per watt of operating power. For example, in an exemplary embodiment, a flash DIMM 240 may be configured with 256 gigabytes (GB) of storage for each 2 watts of operating power. Additionally, a user of flash blade 200 may see reduced operating costs, for example reduced electricity bills and/or cooling bills, due to the lower power consumption and resulting reduced heat generation associated with flash blade 200 when compared to conventional storage blade servers.

In various exemplary embodiments, flash blade 200 is configured to facilitate improvements in the number of input/output operations per second (IOPS) when compared with a conventional storage blade. For example, a particular flash DIMM 240 may be configured to achieve about 20,000 random IOPS (4K read/write) on average. In contrast, a particular enterprise-grade magnetic disk drive may be configured to achieve about 200 random IOPS (4K read/write) on average. Thus, for a particular amount of storage space, use of one or more flash DIMMS 240 enables higher random IOPS for that storage space than would be possible if the storage space were located on a magnetic disk drive. For example, a 1 terabyte (TB) magnetic disk drive may be configured to achieve about 200 random IOPS, thus providing about 200 random TOPS per 1 TB of storage (i.e., about 0.2 random IOPS per GB of storage). In contrast, in an exemplary embodiment, flash blade 200 may be configured with 4 flash DIMMs 240, each having 256 GB of storage space and configured to achieve about 20,000 random IOPS on average. Thus, flash blade 200 may be configured to achieve about 80,000 random IOPS per 1 TB of storage (i.e., about 78 random IOPS per GB of storage)—an improvement of more than two orders of magnitude.

Moreover, multiple flash DIMMs 240 may be utilized in order to achieve higher random IOPS per amount of storage space—for example, use of two flash DIMMs 240, each having 128 GB of storage space and configured to achieve about 20,000 random IOPS on average, would permit flash blade 200 to achieve about 40,000 random IOPS per 256 GB of storage space, use of four flash DIMMs 240, each having 64 GB of storage space and configured to achieve about 20,000 random IOPS on average, would permit flash blade 200 to achieve about 80,000 random IOPS per 256 GB of storage space, and so on. Because flash blade 200 is typically configured with a large number of flash DIMMs 240 (for example, 16 flash DIMMs 240, 32 flash DIMMs 240, and the like), random IOPS significantly larger than those associated with conventional storage blades can be achieved. In one exemplary embodiment, flash blade 200 is configured with 32 flash DIMMS 240, each having 32 GB of storage space and configured to achieve about 20,000 random IOPS on average, allowing flash blade 200 to achieve about 640,000 random IOPS per TB of storage space (i.e., about 625 random IOPS per GB of storage space, or about 0.61 random IOPS per megabyte (MB) of storage space).

By way of comparison, a conventional storage blade configured with 8 magnetic hard drives, each having a storage capacity of about 512 GB and achieving about 200 random IOPS, provides about 4 TB of storage, about 400 random IOPS per TB of storage (i.e., about 0.39 random IOPS per GB), and about 1600 random IOPS in total. In contrast, in an exemplary embodiment, a flash blade 200 configured with 32 flash DIMMS 240, each having 128 GB of storage space and configured to achieve about 20,000 random IOPS on average, provides about 4 TB of storage, about 160,000 random IOPS per TB of storage (i.e., about 156 random IOPS per GB), and about 640,000 random IOPS in total—an improvement of well over two orders of magnitude in IOPS per GB of storage and total random IOPS.

Additionally, each flash DIMM 240 may be configured to achieve a desired level of read and/or write performance. For example, in an exemplary embodiment a flash DIMM 240 is configured to achieve a level of sequential read performance (based on 128 KB blocks) of about 300 MB per second, and a level of sequential write performance (based on 128 KB blocks) of about 200 MB per second. In another exemplary embodiment, a flash DIMM 240 is configured to achieve a level of random read performance (based on 4 KB blocks) of about 25,000 IOPS, and a level of random write performance (based on 4 KB blocks) of about 20,000 IOPS. Similar to previous examples regarding random TOPS per GB, read and/or write performance of flash blade 200 (in terms of MB per second, IOPS, and/or the like) may be improved via use of multiple flash DIMMs 240.

Additionally, because physical storage space may be limited in a blade enclosure or other desired location, flash blade 200 is configured to facilitate improvements in the areal efficiency of information storage. For example, multiple flash DIMMs 240 may be packed closely together on flash blade 200, for example via a spacing of one-half inch centerline to centerline between DIMM sockets. In this manner, a large number of flash DIMMs 240, for example 32 flash DIMMS 240, may be placed on flash blade 200. Additionally, because flash blade 200 is configured to use flash DIMMs 240 instead of storage devices having a disk drive form factor, unnecessary and space-consuming components (e.g., drive bays, drive enclosures, cables, and/or the like) are eliminated. The resulting space may be occupied by one or more additional flash DIMMs 240 in order to achieve a higher information storage areal density than would otherwise be possible. For example, in an exemplary embodiment, a flash blade 200 configured with 32 flash DIMMs 240 (each having 256 GB of storage, configured to achieve about 20,000 random IOPS, and drawing about 2 watts of power) may be configured to fit in a 1U rack slot, achieving a storage density of 8 TB per 1U rack slot.

Moreover, flash blade 200 may be configured to offer additional performance improvements per 1U rack slot. For example, in the foregoing exemplary embodiment, flash blade 200 is configured to provide at least about 640,000 random IOPS per 1U rack slot. In other exemplary embodiments, flash blade 200 is configured to provide at least about 400,000 random IOPS per 1U rack slot. In yet other exemplary embodiments, flash blade 200 is configured to provide at least about 200,000 random IOPS per 1U rack slot. In yet other exemplary embodiments, flash blade 200 is configured to provide at least about 100,000 random IOPS per 1U rack slot.

Additionally, in an exemplary embodiment wherein flash blade 200 draws about 114 watts of power in total (i.e., about 50 watts of base power, plus about 2 watts for each of 32 flash DIMMs comprising flash blade 200), flash blade 200 is configured to draw only about 114 watts of power per 1U rack slot, as compared to typically 250 watts or more per 1U rack slot for a conventional storage blade. By greatly reducing the amount of power drawn per 1U rack slot, flash blade 200 enables reduction in data center power draw and associated cooling and/or ventilation expenses, thus providing more environmentally-friendly data storage.

In various exemplary embodiments, flash blade 200 is configured to communicate with external computers, servers, networks, and/or other suitable electronic devices via a suitable host interface. In an exemplary embodiment, flash blade 200 is coupled to a network via a PCI-Express connection. In another exemplary embodiment, flash blade 200 is coupled to a network via a Fibre Channel connection. Moreover, any suitable communications protocol and/or hardware may be utilized as a host interface, for example SCSI, iSCSI, serial attached SCSI (SAS), serial ATA (SATA), and/or the like. In an exemplary embodiment, flash blade 200 communicates with external electronic devices via a PCI-Express connection having a bandwidth of about 1 GB per second.

Yet further, flash blade 200 may be configured to more effectively utilize host interface bandwidth than a conventional storage blade. For example, a conventional storage blade utilizing magnetic disks is often simply unable to fully utilize available host interface bandwidth, particularly during random reads and writes, due to limitations of magnetic disks (e.g., seek times). For example, a conventional storage blade configured with 8 magnetic disks, each achieving about 200 random IOPS, may utilize a PCI-Express host interface having a bandwidth of about 1 GB per second. However, even if all 8 disks are utilized in parallel, the conventional storage blade is often unable to achieve more than about 800 random IOPS and/or 3.2 MB per second of random read/write performance, and thus utilizes only a fraction of the available host interface bandwidth. Stated another way, performance of a conventional storage blade is usually “back end” limited due to the limitations of the magnetic disks.

In contrast, in an exemplary embodiment, by reading from and/or writing to multiple flash DIMMs 240 in parallel, flash blade 200 is configured to utilize up to about 80% of a PCI-Express host interface having a bandwidth of about 1 GB per second (i.e., flash blade 200 is configured to utilize about 800 MB/sec of the PCI-Express host interface). For random 4K reads and writes, in this embodiment, flash blade 200 is configured to achieve up to about 200,000 random TOPS (800 MB/4K=about 200,000). In another exemplary embodiment, by reading from and/or writing to multiple flash DIMMs 240 in parallel, flash blade 200 is configured to utilize up to about 80% of a PCI-Express host interface having a bandwidth of about 2 GB per second. Thus, in this embodiment, flash blade 200 is configured to achieve up to about 400,000 random TOPS (4K read/write), resulting in data throughput via the host interface of about 1.6 GB/sec.

Thus, via utilization of one or more flash DIMMs 240, flash blade 200 may effectively saturate the available bandwidth of the host interface, for example during sequential reads, sequential writes, and random reads and writes. Stated another way, performance of flash blade 200 may scale in a manner unmatchable by conventional storage blades utilizing magnetic disks, with the associated IOPS limitations. Stated yet another way, in various exemplary embodiments performance of flash blade 200 may be “front end” limited (i.e., by bandwidth of the host interface, for example) rather than “back end” limited (i.e., by limitations on reading/writing the storage media). Moreover, in various exemplary embodiments flash blade 200 may achieve saturation or near-saturation of an available host interface bandwidth via sequential writes, sequential reads, and/or random reads and writes (including random reads and writes of various block sizes, for example 4K blocks, 8K blocks, 32K blocks, 128K blocks, and/or the like).

In various exemplary embodiments, flash blade 200 comprises one or more flash DIMMs 240. In various exemplary embodiments, flash blade 200 does not comprise any magnetic disk drives. Moreover, in certain exemplary embodiments flash blade 200 is configured to be a direct replacement for a legacy storage blade having one or more magnetic disks thereon. For example, flash blade 200 may be installed in a blade enclosure, and may appear to other electronic components (for example, the blade enclosure, other blades in the blade enclosure, host computers accessing flash blade 200 remotely via a communications protocol, and/or the like) as functionally equivalent to a conventional storage blade configured with magnetic disks.

Flash blade 200 may be further configured with any suitable components, algorithms, interfaces, and/or the like, configured to facilitate operation of flash blade 200. In various exemplary embodiments, one or more capabilities of flash blade 200 are implemented via use of a flash blade controller, for example host blade controller 210.

Host blade controller 210 may comprise any components and/or circuitry configured to facilitate operation of flash blade 200. In an exemplary embodiment, host blade controller 210 comprises a field programmable gate array (FPGA). In another exemplary embodiment, host blade controller 210 comprises an application specific integrated circuit (ASIC). In various exemplary embodiments, host blade controller 210 comprises multiple integrated circuits, FPGAs, ASICs, and/or the like. Host blade controller 210 is coupled to one or more flash hubs 230 and/or flash DIMMs 240 via switched fabric 220. Host blade controller 210 may also be coupled to any additional components of flash blade 200 via switched fabric 220 and/or other suitable communication components and/or protocols, as desired.

In an exemplary embodiment, host blade controller 210 is configured to facilitate operations on payload data, for example storage, retrieval, encryption, decryption, and/or the like. Additionally, host blade controller 210 may be configured to implement various data protection and/or processing techniques on payload data, for example mirroring, backup, RAID, and/or the like. Flash blade 200 may thus be configured to provide host blade controller 210 with storage space for use by flash blade controller 210, for example blade controller local storage 212 as depicted in FIG. 2B.

In an exemplary embodiment, host blade controller 210 is configured to define, manage, and/or otherwise allocate and/or control storage space within flash blade 200 provided by one or more flash DIMMs 240. Stated another way, to a user accessing flash blade 200 via a communications protocol, it may appear that flash blade 200 contains one or more storage elements having various configurations. For example, a particular flash blade 200 may be configured with 16 flash DIMMs 240 each having a storage capacity of 16 gigabytes. Host blade controller 210 may be configured to present the resulting 256 gigabytes of storage capacity to a user of flash blade 200 in one or more ways. For example, host blade controller 210 may be configured to present 2 flash DIMMs 240 as a RAID level 1 (mirroring) array having an apparent storage capacity of 16 gigabytes. Host blade controller 210 may also be configured to present 10 flash DIMMs 240 as a concatenated storage area, for example as “just a bunch of disks” (JBOD) having an apparent storage capacity of 160 gigabytes and being addressable via one or more drive letters (e.g., C:, D: E:, etc). Host blade controller 210 may further be configured to present the remaining 4 flash DIMMs 240 as a RAID level 5 array (block level striping with parity) having an apparent storage capacity of 48 gigabytes. Moreover, host blade controller 210 may be configured to present storage space provided by one or more flash DIMMs 240 in any suitable configuration accessible at any suitable granularity, as desired.

In various exemplary embodiments, host blade controller 210 is configured to present a single flash DIMM 240 as a JBOD storage space. The flash DIMM 240 may be configured with 256 GB of storage space, configured to achieve about random 20,000 IOPS, and configured to draw about 2 watts of power. In this embodiment, flash blade 200 is configured to achieve about 128 GB per watt of power drawn by flash DIMM 240, about 78 random IOPS per GB of storage space, and about 10,000 random IOPS per watt of power drawn by flash DIMM 240. In contrast, an enterprise-grade magnetic disk (configured as a JBOD storage space) having a storage space of 1 TB, a random IOPS performance of about 200 IOPS, and a power draw of about 20 watts may achieve only about 50 GB of storage per watt of power drawn by the magnetic disk, about 0.2 random IOPS per GB of storage space, and about 10 random IOPS per watt of power drawn by the magnetic disk.

In another exemplary embodiment, host blade controller 210 is configured to present 8 flash DIMMs 240 as a RAID 0 (striping) array. As before, each flash DIMM 240 may be configured with 256 GB of storage space, configured to achieve about 20,000 random IOPS, and configured to draw about 2 watts of power. In this embodiment, flash blade 200 is configured to present about a 2 TB storage capacity achieving about 160,000 random IOPS, and similar GB/watt, random IOPS/GB, and IOPS/watt performance as the previous example utilizing a single DIMM 240 in a JBOD configuration.

In another exemplary embodiment, host blade controller 210 is configured to present 8 flash DIMMs 240 as a RAID 1 (mirroring) array. This configuration offers high availability due to the four redundant flash DIMMs 240. As before, each flash DIMM 240 may be configured with 256 GB of storage space, configured to achieve about 20,000 random IOPS, and configured to draw about 2 watts of power. In this embodiment, flash blade 200 is configured to present about a 1 TB storage capacity achieving about 93,000 random IOPS and capable of sequential data transfer rates in excess of 600 MB per second. Flash blade 200 is further configured to achieve about 64 GB per watt of power drawn by a flash DIMM 240, about 46 random IOPS per GB of storage space, and about 5,800 random IOPS per watt of power drawn by a flash DIMM 240.

In yet another exemplary embodiment, host blade controller 210 is configured to present 8 flash DIMMs 240 as a RAID 5 (striped set with distributed parity) array. This configuration also offers high availability due to the one redundant flash DIMM 240. As before, each flash DIMM 240 may be configured with 256 GB of storage space, configured to achieve about 20,000 random IOPS, and configured to draw about 2 watts of power. In this embodiment, flash blade 200 is configured to present about a 1.75 TB storage capacity achieving about 140,000 random IOPS and capable of sequential data transfer rates in excess of 600 MB per second. Flash blade 200 is further configured to achieve about 109 GB of storage per watt of power drawn by a flash DIMM 240, about 80 random IOPS per GB of storage space, and about 8,750 random IOPS per watt of power drawn by a flash DIMM 240.

In yet another exemplary embodiment, flash blade 200 is configured with 32 flash DIMMs 240, and host blade controller 210 is configured to present the 32 flash DIMMs 240 as a JBOD storage space. Each flash DIMM 240 may be configured with 256 GB of storage space, configured to achieve about random 20,000 IOPS, and configured to draw about 2 watts of power. The remaining electrical components of flash blade 200 (i.e., electrical components of flash blade 200 exclusive of flash DIMMs 240) may be configured to draw about 50 watts of power in total. Thus, in this exemplary embodiment, flash blade 200 draws about 114 watts of power (2 watts per each of the 32 flash DIMMs 240, and 50 watts for all other electrical components of flash blade 200). In this embodiment, flash blade 200 is configured to achieve about 72 GB of storage per watt of power drawn by flash blade 200, about 78 random IOPS per GB of storage space, and about 5,614 random IOPS per watt of power drawn by flash blade 200. In contrast, a conventional storage blade, configured with four 1 TB hard drives (each drawing about 20 watts of power, and providing about 200 random TOPS), and drawing about 100 watts of base power (for a total power draw of about 180 watts), may achieve only about 22.7 GB of storage per watt of power drawn by the storage blade, about 0.2 random IOPS per GB of storage space, and about 4.4 random IOPS per watt of power drawn by the storage blade.

Host blade controller 210 may be further configured to respond to addition, removal, and/or failure of a flash DIMM 240. For example, when a flash DIMM 240 is added to flash blade 200, host blade controller 210 may allocate the resulting storage space and present it to a user of flash blade 200 as available for storing payload data. Conversely, in anticipation of a particular flash DIMM 240 being removed from flash blade 200, host blade controller 210 may relocate payload data on that flash DIMM 240 to another flash DIMM 240, in order to prevent potential loss of payload data associated with the flash DIMM 240 intended for removal. Host blade controller may also be configured to test, query, monitor, and/or otherwise manage operation of flash DIMMs 240, for example in order to detect a flash DIMM 240 that has failed or is in process of failing, and reroute, recover, duplicate, backup, restore, and/or otherwise take suitable action with respect to any affected portion of payload data.

Host blade controller 210 is configured to communicate with other components of flash blade 200, as desired. In an exemplary embodiment, host blade controller is configured to communicate with other components of flash blade 200 via switched fabric 220.

Continuing to reference FIG. 2A, switched fabric 220 may comprise any suitable structure, components, circuitry, and/or protocols configured to facilitate communication within flash blade 200. In an exemplary embodiment, switched fabric 220 is configured as a switched packet network. In certain exemplary embodiments, switched fabric 220 may be configured with a limited set of packet types (for example, four packet types) and/or packet sizes (for example, two packet sizes) in order to reduce overhead associated with communication via switched fabric 220 and increase communication throughput across switched fabric 220. Switched fabric 220, however, may comprise any suitable packet types, packet sizes, communications protocols, and/or the like, in order to facilitate communication within flash blade 200.

In certain exemplary embodiments, switched fabric 220 is configured with a topology utilizing point-to-point serial links. A pair of links, one in each direction, may be referred to as a “lane”. Switched fabric 220 may thus be configured with one or more lanes between one or more components of flash blade 200, as desired. Moreover, additional lanes may be defined between selected components of flash blade 200, for example between host blade controller 210 and flash hub 230, in order to provide a desired data rate and/or bandwidth between the selected components. Switched fabric 220 can also enable higher data rates between particular components of flash blade 200, as desired, by increasing a clock data rate associated with switched fabric 220. In various exemplary embodiments, switched fabric 220 is configured as a high-speed, 8 gigabits per second per lane format utilizing an 8/10 encoding, providing a bandwidth of about 640 MB per second. However, switched fabric 220 may be configured with any suitable data rates, formatting, encoding, and/or the like, as desired.

Switched fabric 220 is configured to facilitate communication within flash blade 200. In an exemplary embodiment, switched fabric 220 is coupled to flash hub 230.

With continued reference to FIG. 2A, in various exemplary embodiments flash hub 230 may comprise any suitable components, circuitry, hardware and/or software configured to facilitate communication between host blade controller 210 and one or more flash DIMMs 240. In an exemplary embodiment, flash hub 230 is implemented on an FPGA. Flash hub 230 is coupled to one or more flash DIMMs 240 and to switched fabric 220. Payload data, operational commands, and/or the like are sent from host blade controller 210 to flash hub 230 via switched fabric 220. Payload data, responses to operational commands, and/or the like are also returned to host blade controller 210 from flash hub 230 via switched fabric 220. Flash hub 230 is further configured to interface and/or otherwise communicate with one or more flash DIMMs 240.

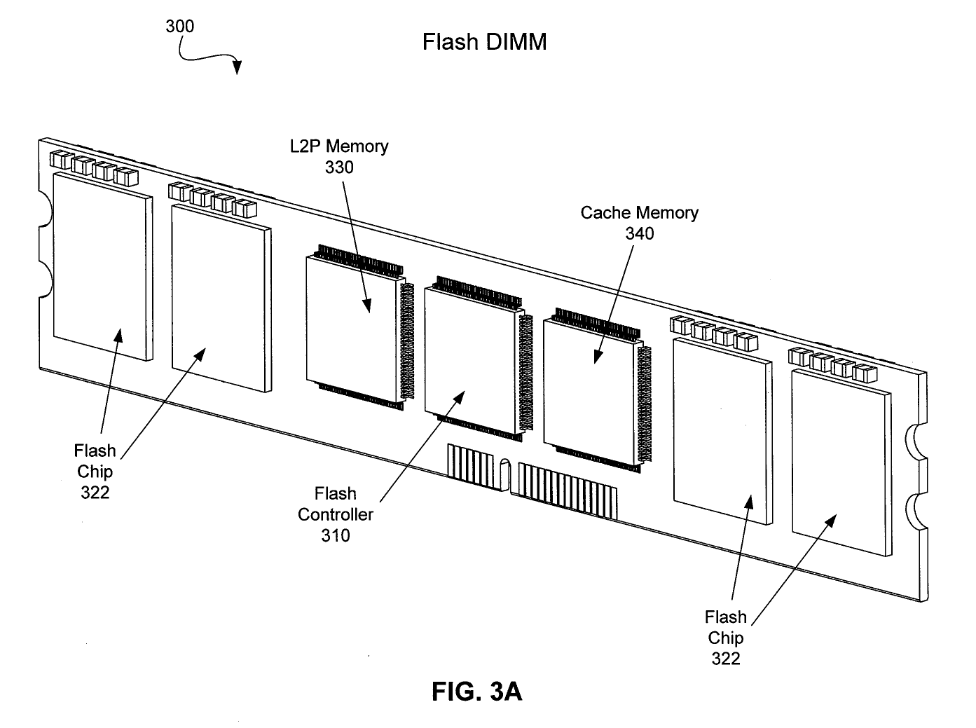

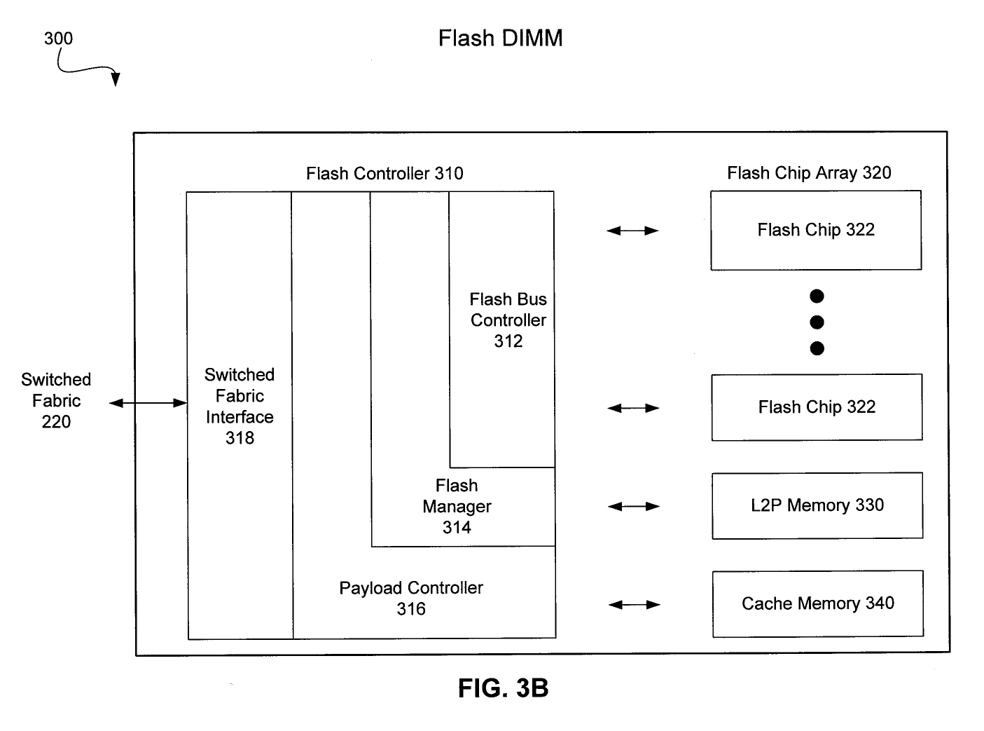

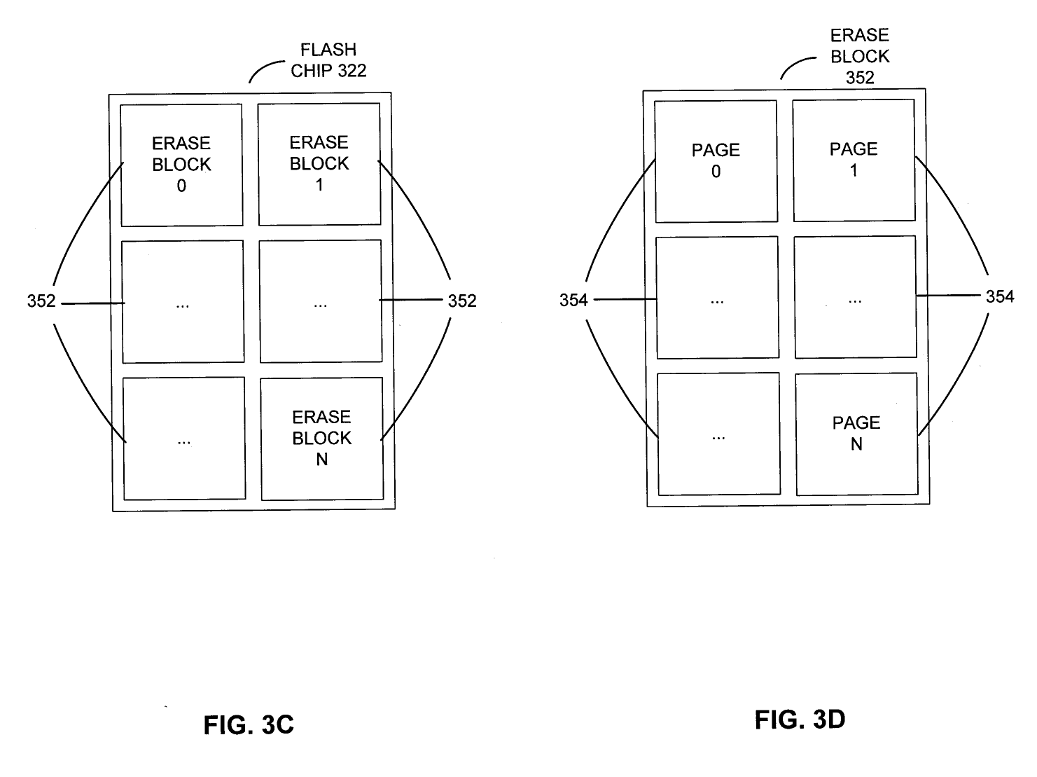

A flash DIMM 240 may comprise any suitable components, chips, circuit boards, memories, controllers, and/or the like, configured to provide non-volatile storage of data, for example payload data, metadata, and/or the like. For example, with momentary reference to FIG. 3A, a flash DIMM 240 (for example, flash DIMM 300) may comprise a printed circuit board having multiple integrated circuits coupled thereto. With reference now to FIGS. 3A and 3B, in an exemplary embodiment, flash DIMM 300 comprises a flash controller 310, a flash chip array 320 comprising flash chips 322, an L2P memory 330, and a cache memory 340. Flash DIMM 300 is configured to store payload data in a non-volatile manner.

Flash DIMM 300 may also be configured to be hot-swappable and/or field-replaceable within flash blade 200. In this manner, flash blade 200 may be upgraded, expanded, and/or otherwise customized or modified via use of one or more flash DIMMs 300. For example, a user desiring additional storage space within flash blade 200 may install one or more additional flash DIMMs 300 into available DIMM slots on flash blade 200. A similar procedure can enable lower-capacity flash DIMMs 300 to be replaced with larger-capacity flash DIMMs 300, as desired. Moreover, a flash DIMM 300 having a first speed grade may be installed in place of a flash DIMM 300 having a second, slower speed grade, a flash DIMM 300 having a multi-level cell configuration may be installed in place of another flash DIMM 300 having a single-level cell configuration, and so on. In addition, a user desiring to replace a damaged and/or defective flash DIMM 300 can remove that flash DIMM 300 from its current DIMM slot, and install a new flash DIMM 300 in place of the previous one. Additionally, flash blade 200 may be configured to monitor and/or otherwise assess the status of flash DIMM 300. For example, flash blade 200 may utilize wear leveling information for a particular flash DIMM 300 to note when that particular flash DIMM 300 may be suggested for replacement. In general, a flash DIMM 300 having any suitable characteristics may be added to flash blade 200 and/or replace another flash DIMM 300 in flash blade 200. Further, flash DIMMs 300 having various similar and/or different characteristics and/or configurations may be simultaneously present in flash blade 200.

Flash DIMM 300 may be configured to draw a desired current level when in operation. For example, in various exemplary embodiments flash DIMM 300 may be configured to draw between about 300 milliamps and about 500 milliamps at 5 volts. In other exemplary embodiments, flash DIMM 300 is configured to draw between about 400 milliamps and about 700 milliamps at 3.3 volts. Moreover, flash DIMM 300 may be configured to draw any suitable current level at any suitable voltage in order to facilitate storage, retrieval, and/or other operations and/or management of payload data on flash DIMM 300. Additionally, flash DIMM 300 may be configured to at least partially power down when not in use, in order to further reduce the power used by flash blade 200. In various exemplary embodiments, operation of flash DIMM 300 is facilitated by flash controller 310.

Flash controller 310 may comprise any suitable components, circuitry, logic, chips, hardware, firmware, software, and/or the like, configured to facilitate control of flash DIMM 300. With reference to FIGS. 3B-3D, in accordance with an exemplary embodiment, flash controller 310 is implemented on an FPGA. In another example, flash controller 310 is implemented on an ASIC. In still other exemplary embodiments, flash controller 310 is implemented across multiple FPGAs and/or ASICs. Further, flash controller 310 may be implemented on any suitable hardware. In accordance with an exemplary embodiment, flash controller 310 comprises a flash bus controller 312, a flash manager 314, a payload controller 316, and a switched fabric interface 318.

In an exemplary embodiment, flash controller 310 is configured to communicate with other components of flash blade 200 via switched fabric 220. In other exemplary embodiments, flash controller 310 is configured to communicate with flash hub 230 via a serial data interface. Moreover, flash controller 310 may be configured to communicate with other components of flash blade 200 via any suitable protocol, mechanism, and/or method.

In various exemplary embodiments, flash controller 310 is configured to receive and optionally queue commands, for example commands generated by host blade controller 210, commands generated by other flash controllers 310 and routed through host blade controller 210, and/or the like. Flash controller 310 is also configured to issue commands to host blade controller 210 and/or other flash controllers 310. Moreover, flash controller 310 may comprise any suitable circuitry configured to receive and/or transmit payload data processing commands. Flash controller 310 may also be configured to implement the logic and computational processes necessary to carry out and respond to these commands. In an exemplary embodiment, flash controller 310 is configured to create, access, and otherwise manage data structures, such as data tables. Further, flash controller 310 is configured to monitor, direct, and/or otherwise govern or control operation of various components of flash controller 310, for example flash bus controller 312, flash manager 314, payload controller 316, and/or switched fabric interface 318, in order to implement one or more desired tasks associated with flash chip array 320, for example read, write, garbage collection, wear leveling, error detection, error correction, bad block management, and/or the like. In an exemplary embodiment, flash controller 310 is configured with flash bus controller 312.

Flash bus controller 312 may comprise any suitable components and/or circuitry configured to provide an interface between flash controller 310 and flash chip array 320. In an exemplary embodiment, flash bus controller 312 is configured to communicate with and control one or more flash chips 322. In various exemplary embodiments, flash bus controller 312 is configured to provide error correction code generation and checking capabilities. In certain exemplary embodiments, flash bus controller 312 is configured as a low-level controller suitable to process commands, for example open NAND flash interface (ONFI) commands and/or the like. Moreover, flash bus controller 312 may be customized, tuned, configured, and/or otherwise updated and/or modified in order to achieve improved performance depending on the particular flash chips 322 comprising flash chip array 320. Additionally, flash bus controller 312 is configured to interface with and/or otherwise operate responsive to operation of flash manager 314.

Flash manager 314 may comprise any suitable components and/or circuitry configured to facilitate mapping of logical pages to areas of physical non-volatile memory on a flash chip 322. In various exemplary embodiments, flash manager 314 is configured to support, facilitate, and/or implement various operations associated with one or more flash chips 322, for example reading, writing, wear leveling, defragmentation, flash command queuing, error correction, error detection, fault detection, page replacement, and/or the like. Accordingly, flash manager 314 may be configured to interface with one or more data storage components configured to store information about a flash chip 322, for example L2P memory 330. Flash manager 314 may thus be configured to utilize one or more data structures, for example a logical to physical (L2P) table and/or a physical erase block (PEB) table.

In various exemplary embodiments, entries in a L2P table contain physical addresses for logical memory pages. Entries in a L2P table may also contain additional information about the page in question. In certain exemplary embodiments, the size of an L2P table may define the apparent capacity of an associated flash chip array 320 or a portion thereof.

In various exemplary embodiments, an L2P table may contain information configured to map a logical page to a logical erase block and page. For example, in an exemplary embodiment, in an L2P table an entry contains 22 bits: an erase block number (16 bits), and a page offset number (6 bits). With momentary reference to FIGS. 3C and 3D, the erase block number identifies a specific logical erase block 352 in flash chip array 320, and the page offset number identifies a specific page 354 within erase block 352. The number of bits used for the erase block number and/or the page offset number may be increased or decreased depending on the number of flash chips 322, erase blocks 352, and/or pages 354 desired to be indexed.

In an exemplary embodiment, data structures, such as data tables, are constructed using erase block index information stored in the final page of each erase block 352. Data tables may be constructed when flash chip array 320 is powered on. In another exemplary embodiment, data tables are constructed using the metadata associated with each page 354 in flash chip array 320. Again, data tables may be constructed when flash chip array 320 is powered on. Additionally, data tables may be constructed, updated, modified, and/or revised at any appropriate time to enable operation of flash chip array 320.

Additionally, erase blocks 352 in flash chip array 320 may be managed via a data structure, such as a PEB table. A PEB table may be configured to contain any suitable information about erase blocks 352. In an exemplary embodiment, a PEB table contains information configured to locate erase blocks 352 in flash chip array 320.

In an exemplary embodiment, a PEB table is located in its entirety in random access memory (RAM) within L2P memory 330. Further, a PEB table may be configured to store information about each erase block 352 in flash chip array 320, such as the flash chip 322 where erase block 352 is located (i.e. a chip select (CS) value), the location of erase block 352 on flash chip 322, the state (e.g. dirty, erased, and the like) of pages 354 in erase block 352, the number of pages 354 in erase block 352 which currently hold payload data, a preferred next page within erase block 352 available for writing incoming payload data, information regarding the wear status of erase block 352, and/or the like. Further, pages 354 within erase block 352 may be tracked, such that when a particular page is deemed unusable, the remaining pages in erase block 352 may still be used, rather than marking the entire erase block 352 containing the unusable page 354 as unusable.

Additionally, the size and/or contents of a PEB table and/or other data structures may be varied in order to allow tracking and management of operations on portions of an erase block 352 smaller than one page in size. Prior approaches typically tracked a logical page size which was equal to the physical page size of the flash memory device in question. In contrast, because an increase in a physical page size often imposes additional data transfer latency or other undesirable effects, in various exemplary embodiments, a logical page size smaller than a physical page size is utilized. In this manner, data transfer latency associated with flash chip array 320 may be reduced. For example, when a logical page size LPS is equal to a physical page size PPS, the number of entries in a PEB table may be a value X. By doubling the number of entries in the PEB table to a value 2X, twice as many logical pages may be managed. Thus, logical page size LPS may now be half as large as physical page size PPS. Stated another way, two logical pages may now correspond to one physical page. Similarly, in an exemplary embodiment, the number of entries in a PEB table may be varied such that any suitable number of logical pages may correspond to one physical page.

Moreover, the size of a physical page in a first flash chip 322 may be different than the size of a physical page in a second flash chip 322 within the same flash chip array 320. Additionally, the size of a physical page in a first flash chip 322 in a first flash chip array 320 may be different from the size of a physical page in a second flash chip 322 in a second flash chip array 320. Thus, in various exemplary embodiments, a PEB table may be configured to manage a first number of logical pages per physical page for a first flash chip 322, a second number of logical pages per physical page for a second flash chip 322, and so on. In this manner, multiple flash chips 322 of various capacities and/or configurations may be utilized within flash chip array 320 and/or within flash blade 200.

Additionally, a flash chip 322 may comprise one or more erase blocks 352 containing at least one page that is “bad”, i.e. defective or otherwise unreliable and/or inoperative. In certain previous approaches, when a bad page was discovered, the entire erase block 352 containing a bad page was marked as unusable, preventing other “good” pages within that erase block 352 from being utilized. To avoid this condition, in various exemplary embodiments, a PEB table and/or other data structures, such as a defect list, may be configured to allow use of good pages within an erase block 352 having one or more bad pages. For example, a PEB table may comprise a series of “good/bad” indicators for one or more pages. Such indicators may comprise a status bit for each page. If information in a PEB table indicates a particular page is good, that page may be written, read, and/or erased as normal. Alternatively, if information in a PEB table indicates a particular page is bad, that page may be blocked from use. Stated another way, flash controller 310 may be prevented from writing to and/or reading from a bad page. In this manner, good pages within flash chip 322 may be more effectively utilized, extending the lifetime of flash chip 322.

In addition to an L2P table and a PEB table, other data structures, such as data tables, may be configured to manage the contents of flash chip array 320. In an exemplary embodiment, an L2P table, a PEB table, and all other data tables configured to manage the contents of flash chip array 320 are located in their entirety in RAM contained in and/or associated with L2P memory 330. In other exemplary embodiments, an L2P table, a PEB table, and all other data tables configured to manage the contents of flash chip array 320 are located in any suitable location configured for storing data structures.

According to an exemplary embodiment, data structures configured to manage the contents of flash chip array 320 are stored in their entirety in RAM on flash DIMM 300. In this exemplary embodiment, no portion of data structures configured to manage the contents of flash chip array 320 are stored on a hard disk drive, solid state drive, magnetic tape, or other non-volatile medium. Prior approaches were unable to store these data structures in their entirety in RAM due to the limited availability of space in RAM. But now, large amounts of RAM, such as 512 megabytes, 1 gigabyte, or more, are relatively inexpensive and are now commonly available for use in flash DIMM 300. Because data structures may be stored in their entirety in RAM, which may be quickly accessed, the speed of operations on flash chip array 320 can be increased when compared to former approaches, for example approaches which stored only a small portion of a data table in RAM, and stored the remainder of a data table on a slower, nonvolatile medium. In other exemplary embodiments, portions of data structures, such as infrequently accessed portions, are strategically stored in non-volatile memory. Such an approach balances the performance improvements realized by keeping data structures in RAM with the potential need to free up portions of RAM for other uses.

With reference again to FIG. 3B, payload controller 316 may comprise any suitable components and/or circuitry configured to provide an interface between flash controller 310 and cache memory 340. In an exemplary embodiment, payload controller 316 is configured to convert data packets received from switch fabric 220 into flash pages suitable for processing in the flash controller domain, and vice versa. Payload controller 316 also houses payload cache hardware, for example cache hardware configured to improve IOPS performance. Payload controller 316 may also be configured to perform additional data processing on the flash pages, such as encryption, decryption, and/or the like. Payload controller 316, flash manager 314, and flash bus controller 312 are configured to operate responsive to commands generated within flash controller 310 and/or received via switched fabric interface 318.

Switched fabric interface 318 may comprise any suitable components and/or circuitry configured to provide an interface between flash DIMM 300 and other components of flash blade 200, for example flash hub 230 and/or switched fabric 220. In an exemplary embodiment, switched fabric interface 318 is configured to receive and/or transmit commands, payload data, and/or other suitable information via switched fabric 220. Switched fabric interface 318 may thus be configured with various buffers, caches, and/or the like. In an exemplary embodiment, switched fabric interface 318 is configured to interface with host blade controller 210. Switched fabric interface 318 is further configured to facilitate control of the flow of payload data between host blade controller 210 and flash controller 310.

With continued reference to FIG. 3B and with momentary reference to FIG. 1, a storage component 101C, for example flash chip array 320, may comprise any components suitable for storing information in electronic form. In an exemplary embodiment, flash chip array 320 comprises one or more flash chips 322. Any suitable number of flash chips 322 may be selected. In an exemplary embodiment, a flash chip array 320 comprises sixteen flash chips. In various exemplary embodiments, other suitable numbers of flash chips 322 may be selected, such as one, two, four, eight, or thirty-two flash chips. Flash chips 322 may be selected to meet storage size, power draw, and/or other desired characteristics of flash chip array 320.

In an exemplary embodiment, flash chip array 320 comprises flash chips 322 having similar storage sizes. In various other exemplary embodiments, flash chip array 320 comprises flash chips 322 having different storage sizes. Any number of flash chips 322 having various storage sizes may be selected. Further, a number of flash chips 322 having a significant number of unusable erase blocks 352 and/or pages 354 may comprise flash chip array 320. In this manner, one or more flash chips 322 which may have been unsuitable for use in a particular flash chip array 320 can now be utilized. For example, a particular flash chip 322 may contain 2 gigabytes of storage capacity. However, due to manufacturing processes or other factors, 1 gigabyte of the storage capacity on this particular flash chip 322 may be unreliable or otherwise unusable. Similarly, another flash chip 322 may contain 4 gigabytes of storage capacity, of which 512 megabytes are unusable. These two flash chips 322 may be included in a flash chip array 320. In this example, flash chip array 320 contains 6 gigabytes of storage capacity, of which 4.5 gigabytes are usable. Thus, the total storage capacity of flash chip array 320 may be reported as any size up to and including 4.5 gigabytes. In this manner, the cost of flash chip array 320 and/or flash DIMM 300 may be reduced, as flash chips 322 with higher defect densities are often less expensive. Moreover, because flash chip array 320 may utilize various types and sizes of flash memory, one or more flash chips 322 may be utilized instead of being discarded as waste. In this manner, principles of the present disclosure, for example utilization of flash blade 200, can help reduce environmental degradation related to disposal of unused flash chips 322.

In an exemplary embodiment, the reported storage capacity of flash chip array 320 may be smaller than the actual storage capacity, for such reasons as to compensate for the development of bad blocks, provide space for defragmentation operations, provide space for index information, extend the useable lifetime of flash chip array 320, and/or the like. For example, flash chip array 320 may comprise flash chips 322 having a total useable storage capacity of 32 gigabytes. However, the reported capacity of flash chip array 320 may be 8 gigabytes. Thus, because only approximately 8 gigabytes of space within flash chip array 320 will be utilized for active storage, individual memory elements in flash chip array 320 may be utilized in a reduced manner, and the useable lifetime of flash chip array 320 may be extended. In the present example, when the reported capacity of flash chip array 320 is 8 gigabytes, the useable lifetime of a flash chip array 320 with useable storage capacity of 32 gigabytes would be about four times longer than the useable lifetime of a flash chip array 320 containing only 8 gigabytes of total useable storage capacity, because the reported storage capacity is the same but the actual capacity is four times larger.

In various embodiments, flash chip array 320 comprises multiple flash chips 322. As disclosed hereinbelow, each flash chip 322 may have one or more bad pages 354 which are not suitable for storing data. However, flash chip array 320 and/or flash DIMM 300 may be configured in a manner which allows at least a portion of otherwise unusable good pages 354 (for example, good pages 354 located in the same erase block 352 as one or more bad pages 354) within each flash chip 322 to be utilized.

Flash chips 322 may be mounted on a printed circuit board (PCB), for example a PCB configured for use as a DIMM. Flash chips 322 may also be mounted in other suitable configurations in order to facilitate their use in forming flash chip array 320.

In an exemplary embodiment, flash chip array 320 is configured to interface with flash controller 310 via flash bus controller 312. Flash controller 310 is configured to facilitate reading, writing, erasing, and other operations on flash chips 322. Flash controller 310 may be configured in any suitable manner to facilitate operations on flash chips 322 in flash chip array 320.

In flash chip array 320, and according to an exemplary embodiment, individual flash chips 322 are configured to receive a chip select (CS) signal. A CS signal is configured to locate, address, and/or activate a flash chip 322. For example, in a flash chip array 320 with eight flash chips 322, a three-bit binary CS signal would be sufficient to uniquely identify each individual flash chip 322. In an exemplary embodiment, CS signals are sent to flash chips 322 from flash controller 310. In another exemplary embodiment, discrete CS signals are decoded within flash controller 310 from a three-bit CS value and applied individually to each of the flash chips 322.

In an exemplary embodiment, multiple flash chips 322 in flash chip array 320 may be accessed simultaneously and in a parallel fashion. Overlapped, simultaneous and parallel access can facilitate performance gains, such as improvements in responsiveness and throughput of flash chip array 320. For example, flash chips 322 are typically accessed through an interface, such as an 8-bit bus interface. If two identical flash chips 322 are provided, these flash chips 322 may be logically connected such that an operation (read, write, erase, and the like) performed on the first flash chip 322 is also performed on the second flash chip 322, utilizing identical commands and addressing. Thus, data transfers can happen in tandem, effectively doubling the effective data rate without increasing data transfer latency. However, in this configuration, the logical page size and/or logical erase block size may also double. Moreover, any number of similar and/or different flash chips 322 may comprise flash chip array 320, and flash controller 310 may utilize flash chips 322 within flash chip array 320 in any suitable manner in order to achieve one or more desired performance and/or configuration objectives (e.g., storage size, data throughput, data redundancy, flash chip lifetime, read time, write time, erase time, and/or the like).

Continuing to reference FIG. 3B, flash chip 322 may comprise any components and/or circuitry configured to store information in an electronic format. In an exemplary embodiment, flash chip 322 comprises an integrated circuit fabricated on a single piece of silicon or other suitable substrate. Alternatively, flash chip 322 may comprise integrated circuits fabricated on multiple substrates. One or more flash chips 322 may be packaged together in a standard package such as a thin small outline package, ball grid array, stacked package, land grid array, quad flat package, or other suitable package, such as standard packages approved by the Joint Electron Device Engineering Council (JEDEC). A flash chip 322 may also conform to specifications promulgated by the Open NAND Flash Interface Working Group (OFNI). A flash chip 322 can be fabricated and packaged in any suitable manner for inclusion in a flash chip array 320. In various exemplary embodiments, flash chip 322 comprises Intel part number JS29F16G08AAND2 (16 gigabit), JS29F32G08CAND2 (32 gigabit), and/or JS29F64G08JAND2 (64 gigabit). In other exemplary embodiments, flash chip 322 comprises Intel part number JS29F08G08AANC1 (8 gigabit), JS29F16G08CANC1 (16 gigabit), and/or JS29F32G08FANC1 (32 gigabit). In an exemplary embodiment, flash chip 322 comprises Samsung part number K9FAGD8U0M (16 gigabit). Moreover, flash chip 322 may comprise any suitable flash memory storage component, and the examples given are by way of illustration and not of limitation.

Flash chip 322 may contain any number of non-volatile memory elements, such as NAND flash elements, NOR flash elements, phase-change memory (PCM), magnetoresistive random access memory (MRAM), and/or the like. Flash chip 322 may also contain control circuitry. Control circuitry can facilitate reading, writing, erasing, and other operations on non-volatile memory elements. Such control circuitry may comprise elements such as microprocessors, registers, buffers, counters, timers, error correction circuitry, and input/output circuitry. Such control circuitry may also be located external to flash chip 322, for example within flash controller 310.

In an exemplary embodiment, non-volatile memory elements on flash chip 322 are configured as a number of erase blocks 0 to N. With momentary reference to FIGS. 3C and 3D, a flash chip 322 comprises one or more erase blocks 352. Each erase block 352 comprises one or more pages 354. Each page 354 comprises a subset of the non-volatile memory elements within an erase block 352. In general, each erase block 352 contains about 1/N of the non-volatile memory elements located on flash chip 322.

Because flash memory, particularly NAND flash memory, may often be erased only in certain discrete sizes at a time, flash chip 322 typically contains a large number of erase blocks 352. Such an approach allows operations on a particular erase block 352, such as erase operations, to be conducted without disturbing data located in other erase blocks 352. Alternatively, were flash chip 322 to contain only a small number of erase blocks 352, data to be erased and data to be preserved would be more likely to be located within the same erase block 352. In the extreme example where flash chip 322 contains only a single erase block 352, any erase operation on any data contained in flash chip 322 would require erasing the entire flash chip 322. If any data on flash chip 322 was desired to be preserved, that data would need to be read out before the erase operation, stored in a temporary location, and then re-written to flash chip 322. Such an approach has significant overhead, and could lead to premature failure of the flash memory due to excessive, unnecessary read/write cycles.

With reference now to FIGS. 3C and 3D, in an exemplary embodiment an erase block 352 comprises a subset of the non-volatile memory elements located on flash chip 322. Although memory elements within erase block 352 may be programmed and read in smaller groups, all memory elements within erase block 352 may only be erased together. Each erase block 352 is further subdivided into any suitable number of pages 354. A flash chip array 320 may be configured to comprise flash chips 322 containing any suitable number of pages 354.

A page 354 comprises a subset of the non-volatile memory elements located within an erase block 352. In an exemplary embodiment, there are 64 pages 354 per erase block 352. To form flash chip array 320, flash chips 322 comprising any suitable number of pages 354 per erase block 352 may be selected.

In addition to memory elements used to store payload data, a page 354 may have memory elements configured to store error detection information, error correction information, and/or other information intended to ensure safe and reliable storage of payload data. In an exemplary embodiment, metadata stored in a page 354 is protected by error correction codes. In various exemplary embodiments, a portion of erase block 352 is protected by error correction codes. This portion may be smaller than, equal to, or larger than one page.

Returning again to FIG. 3B, L2P memory 330 may comprise any components and/or circuitry configured to facilitate access to payload data stored in flash chip array 320. For example, L2P memory 330 may comprise RAM. In an exemplary embodiment, L2P memory 330 is configured to hold one or more data structures associated with flash manager 314.

Cache memory 340 may comprise any components and/or circuitry configured to facilitate processing and/or storage of payload data. For example, cache memory 340 may comprise RAM. In an exemplary embodiment, cache memory 340 is configured to interface with payload controller 316 in order to provide temporary storage and/or buffering of payload data retrieved from and/or intended for storage in flash chip array 320.

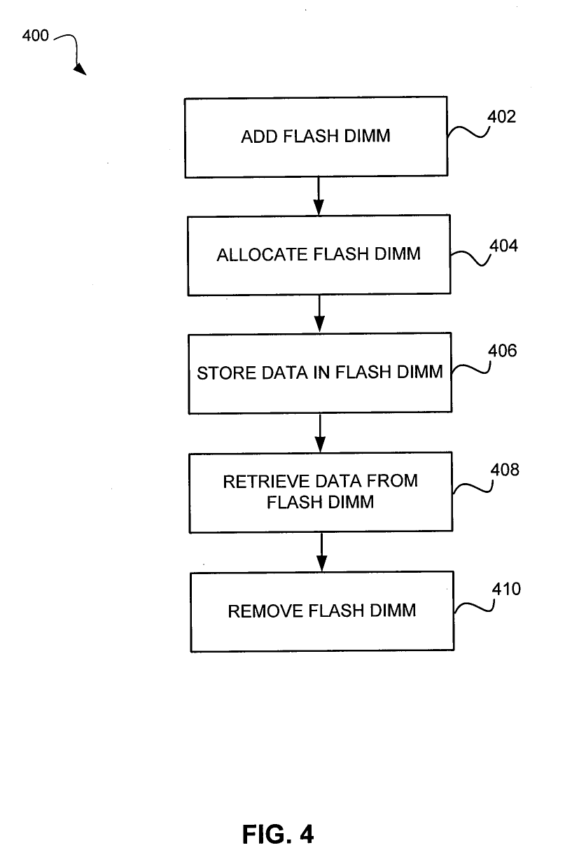

Once flash blade 200 has been configured for use by a user, flash blade 200 may be further customized, upgraded, revised, and/or configured, as desired. For example, with reference to FIGS. 2A and 4, in an exemplary embodiment a method for using a flash DIMM 240 in a flash blade 200 comprises adding flash DIMM 240 to flash blade 200 (step 402), allocating at least a portion of the storage space of flash DIMM 240 (step 404), storing payload data in flash DIMM 240 (step 406), and retrieving payload data from flash DIMM 240 (step 408). Flash DIMM 240 may also be removed from flash blade 200 (step 410).

A flash DIMM 240 may be added to flash blade 200 as disclosed hereinabove (step 402). Multiple flash DIMMs 240 may be added, and flash DIMMs 240 may suitably comprise different storage capacities, flash chips 322 from different vendors, and/or the like, as desired. In this manner, a variety of flash DIMMs 240 may be added to flash blade 200, allowing a user to customize their investment in flash blade 200 and/or the capabilities of flash blade 200.

After a flash DIMM 240 has been added to flash blade 200, at least a portion of the storage space on flash DIMM 240 may be allocated for storage of payload data, metadata, and/or other data, as desired (step 404). For example, one flash DIMM 240 added to flash blade 200 may be configured as a virtual drive having a capacity equal to or less than the storage capacity of that flash DIMM 240. A flash DIMM 240 may be configured and/or allocated in any suitable manner in order to enable storage of payload data, metadata, and/or other data within that flash DIMM 240.

After at least a portion of the storage space in a flash DIMM 240 has been allocated, payload data may be stored in that flash DIMM 240 (step 406). For example, a user of flash blade 200 may transmit an electronic file to flash blade 200 in connection with a data storage request. The electronic file may arrive at flash blade 200 as a collection of payload data packets. Flash blade 200 may then store the electronic file on a flash DIMM 240 as a collection of payload data packets. Flash blade 200 may also store the electronic file on a flash DIMM 240 as an electronic file assembled, encrypted, and/or otherwise reconstituted, generated, and/or or modified from a collection of payload data packets. Moreover, a flash blade 200 may store information, including but not limited to payload data, metadata, electronic files, and/or the like, on multiple flash DIMMs 240 and/or across multiple flash blades 200, as desired.

Data stored in a flash DIMM may be retrieved (step 408). For example, a user may transmit a read request to a flash blade 200, requesting retrieval of payload data stored in flash blade 200. The requested payload data may be retrieved from one or more flash DIMMs 240, transmitted via switched fabric 220 to host blade controller 210, and delivered to the user via any suitable electronic communication network and/or protocol. Moreover, multiple read and/or write requests may be handled simultaneously by flash blade 200, as desired.

A flash DIMM 240 may be removed from flash blade 200 (step 410). For example, a user may desire to replace a first flash DIMM 240 having a storage capacity of 4 gigabytes with a second flash DIMM 240 having a storage capacity of 16 gigabytes. In an exemplary embodiment, flash blade 200 is configured to allow removal of a flash DIMM 240 without prior notice to flash blade 200. For example, flash blade 200 may configure multiple flash DIMMs 240 in a RAID array such that one or more flash DIMMs 240 in the RAID array may be removed and/or replaced without notice to flash blade 200 without adverse effect on payload data stored in flash blade 200. In other exemplary embodiments, flash blade 200 is configured to prepare a flash DIMM 240 for removal from flash blade 200 by copying and/or otherwise moving and/or duplicating information on the flash DIMM 240 elsewhere within flash blade 200. In this manner, loss of payload data or other valuable data is prevented.

Principles of the present disclosure may suitably be combined with principles of sequential writing as disclosed in U.S. patent application Ser. No. 12/103,273 filed Apr. 15, 2008 and entitled “FLASH MANAGEMENT USING SEQUENTIAL TECHNIQUES,” now published as U.S. Patent Application Publication No. 2009/0259800, the contents of which are hereby incorporated by reference in their entirety.

Principles of the present disclosure may also suitably be combined with principles of circular wear leveling as disclosed in U.S. patent application Ser. No. 12/103,277 filed Apr. 15, 2008 and entitled “CIRCULAR WEAR LEVELING,” now published as U.S. Patent Application Publication No. 2009/0259801, the contents of which are hereby incorporated by reference in their entirety.

Principles of the present disclosure may also suitably be combined with principles of logical page size as disclosed in U.S. patent application Ser. No. 12/424,461 filed Apr. 15, 2009 and entitled “FLASH MANAGEMENT USING LOGICAL PAGE SIZE,” now published as U.S. Patent Application Publication No. 2009/0259805, the contents of which are hereby incorporated by reference in their entirety.

Principles of the present disclosure may also suitably be combined with principles of bad page tracking as disclosed in U.S. patent application Ser. No. 12/424,464 filed Apr. 15, 2009 and entitled “FLASH MANAGEMENT USING BAD PAGE TRACKING AND HIGH DEFECT FLASH MEMORY,” now published as U.S. Patent Application Publication No. 2009/0259806, the contents of which are hereby incorporated by reference in their entirety.

Principles of the present disclosure may also suitably be combined with principles of separate metadata storage as disclosed in U.S. patent application Ser. No. 12/424,466 filed Apr. 15, 2009 and entitled “FLASH MANAGEMENT USING SEPARATE METADATA STORAGE,” now published as U.S. Patent Application Publication No. 2009/0259919, the contents of which are hereby incorporated by reference in their entirety.

Moreover, principles of the present disclosure may suitably be combined with any number of principles disclosed in any one of and/or all of the co-pending U.S. patent applications incorporated by reference herein. Thus, for example, a flash blade architecture and/or flash DIMM may utilize a combination of memory management techniques that may include use of a logical page size different from a physical page size, use of separate metadata storage, use of bad page tracking, use of sequential write techniques, use of circular leveling techniques, and/or the like.

As will be appreciated by one of ordinary skill in the art, principles of the present disclosure may be reflected in a computer program product on a tangible computer-readable storage medium having computer-readable program code means embodied in the storage medium. Any suitable computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

In the foregoing specification, the disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A method for managing payload data, the method comprising:
receiving, responsive to a payload data storage request, payload data at a flash blade;
storing the payload data in a flash DIMM on the flash blade; and
retrieving, responsive to a payload data retrieval request, payload data from the flash DIMM.

2. The method of claim 1, wherein the flash DIMM is removable from the flash blade.

3. The method of claim 1, wherein the flash DIMM is hot-swappable.

4. The method of claim 1, wherein the flash blade is configured to provide at least 100 GB of storage per watt of power drawn by the flash blade.

5. The method of claim 1, wherein the flash blade is configured with multiple flash DIMMs.

6. The method of claim 5, wherein payload data is written to at least two flash DIMMs in a parallel manner.

7. The method of claim 5, wherein payload data is retrieved from at least two flash DIMMs in a parallel manner.

8. The method of claim 5, wherein the multiple flash DIMMs are configured as a payload data storage area, and wherein the payload data storage area is divided at a granularity smaller than the capacity of a flash DIMM.

9. The method of claim 5, further comprising configuring at least two flash DIMMs of the multiple flash DIMMs to function as a RAID array.

10. The method of claim 9, further comprising recreating at least a portion of payload data responsive to at least one of: removal of a flash DIMM from the flash blade, or operational failure of a flash DIMM on the flash blade.

11. The method of claim 1, wherein the payload data is stored in the flash DIMM in the order it was received at the flash blade.

12. The method of claim 1, further comprising defining a circular storage area composed of erase blocks on a flash DIMM, wherein storing the payload data in a flash DIMM comprises writing the payload data in the order it was received at the flash blade to at least one erase block in the circular storage space.

13. The method of claim 12, wherein the circular storage space spans multiple flash DIMMs.

14. The method of claim 1, further comprising constructing a data table associated with the flash DIMM, wherein entries of the data table correspond to logical pages within the flash DIMM, and wherein the size of the logical pages is smaller than a size of a physical page in the flash DIMM.

15. The method of claim 1, further comprising storing, on the flash blade, defect information for one or more erase blocks in the flash DIMM; and
constructing a data table associated with the flash DIMM, wherein entries of the data table correspond to physical portions within the flash DIMM, wherein the size of the physical portions is smaller than the size of an erase block in the flash DIMM, and wherein entries of the data table comprise defect information associated with the physical portions.

16. The method of claim 1, further comprising storing, on the flash blade, at least one of metadata or error correcting information, wherein the stored information is associated with one or more logical pages in a flash DIMM; and
constructing a data table associated with the flash DIMM, wherein entries of the data table correspond to logical pages within the flash DIMM, and wherein entries of the data table comprise at least one of metadata or error correcting information associated with the logical pages.

17. The method of claim 1, wherein the flash blade is configured to provide at least 100 random IOPS per watt of power drawn by the flash blade, and
wherein the flash blade is configured to provide at least 100 random IOPS per gigabyte (GB) of storage space on the flash blade.

18. A method for storing information, the method comprising:
providing a flash blade having an information storage area thereon, wherein the information storage area comprises a plurality of information storage components;
storing, in the information storage area, at least one portion of information; and
replacing at least one of the information storage components while the flash blade is operational.

19. The method of claim 18, wherein the at least one information storage component is a flash DIMM.

20. The method of claim 18, wherein the information storage area is configured as an address space divisible at a chosen granularity.

21. A flash blade, comprising:
a host blade controller configured to process payload data;
a flash DIMM configured to store the payload data; and
a switched fabric configured to facilitate communication between the host blade controller and the flash DIMM.

22. The flash blade of claim 21, wherein the flash DIMM is removable from the flash blade.

23. The flash blade of claim 21, wherein the flash DIMM is hot-swappable.

24. The flash blade of claim 23, further comprising a plurality of flash DIMMs, wherein at least some of the plurality of flash DIMMs are configured as a RAID array.

25. The flash blade of claim 23, further comprising a plurality of flash DIMMs, wherein at least some of the plurality of flash DIMMs are configured as a concatenated data storage area.

26. The flash blade of claim 21, wherein the flash blade is configured to achieve performance in excess of 100 random IOPS per watt of power drawn by the flash blade,
wherein the flash blade is configured to achieve performance in excess of 100 random IOPS per 1 GB of storage space on the flash blade, and
wherein the flash blade is configured to achieve performance in excess of 100,000 random IOPS per 1U of rack space.

27. A non-transitory computer-readable medium having instructions stored thereon, that, if executed by a system, cause the system to perform operations comprising:
receiving, responsive to a payload data storage request, payload data at a flash blade;
storing the payload data in a flash DIMM on the flash blade; and
retrieving, responsive to a payload data retrieval request, payload data from the flash DIMM.
